(19) United States
(12) Patent Application Publication
(10) Pub. No.: US 2014/0132009 A1
(43) Pub. Date: May 15, 2014

(54) LATCH DEVICE FOR AN EXIT DEVICE FOR A DOOR

(71) Applicant: STANLEY SECURITY SOLUTIONS TAIWAN LTD., Chia-Yi (TW)

(72) Inventors: Wei-Liang CHIANG, Chiayi City (TW); Kun-Chen LEE, Chiayi County (TW); You-Fang YE, Chiayi County (TW); Po-Yang CHEN, Chiayi City (TW)

(73) Assignee: STANLEY SECURITY SOLUTIONS TAIWAN LTD., Chia-Yi (TW)

(21) Appl. No.: 14/075,456

(22) Filed: Nov. 8, 2013

(30) Foreign Application Priority Data
Nov. 12, 2012 (TW) 101221797

(51) Int. Cl. E05C 1/08; E05B 55/00

(52) U.S. Cl. CPC E05C 1/08; E05B 55/00
USPC 292/156; 292/138; 292/164

(57) ABSTRACT

A latch device for an exit device (1) includes a base (20) mounted to a side of a door. A first sliding member (30) is mounted to the base (20) and is movable relative to the base (20) between a first position and a second position. A stop (72) is mounted in a receiving portion (322) of the first sliding member (30) and is pivotable relative to the first sliding member (30) between first and second angular positions. A latch head (60) is mounted to the base (20) and is pivotable relative to the base (20) between a retracted position and in extended position. An abutment portion (725) of the stop (72) in the second angular position is located in a pivotal path of the latch head (60).

### CROSS REFERENCE TO RELATED APPLICATION

This application claims the priority of Taiwanese Utility Model Application No. 101221797, filed Nov. 12, 2012, the entire contents of which are herein incorporated by reference.

### BACKGROUND OF THE INVENTION

The present invention relates to a latch device for an exit device for a door and, more particularly, to a burglarproof latch device for an exit device mounted to a panic exit door, allowing rapid retraction of a latch head of the latch device when a press bar of the exit device is pressed.

Besides a handle or an exit device for controlling opening/closing, passageway doors mounted in houses or buildings generally include a top latch located between a top end of the door and a door frame and a bottom latch located between a bottom end of the door and a floor. The top and bottom latches increase the structural strength while the door is in a latched state and increase the difficulty of picking by illegal intruders. The top and bottom latches are generally mounted to the top and bottom ends of a panic exit door in a house or building. However, controlling or unlatching of the top and bottom latches requires a complicated structure. Furthermore, the latch head of the top latch or bottom latch is liable to protrude toward the door frame or the floor and is, thus, apt to wear and damage, failing to provide durable utility. Further, general top and bottom latches do not provide a burglarproof function. Thus, a need exists for a novel latch device to overcome the disadvantages of conventional top and bottom latches for doors, increasing the functions and effects of the top and bottom latches.

### BRIEF SUMMARY OF THE INVENTION

The primary objective of the present invention is to provide a latch device for an exit device for a door that is burglarproof, simple in structure, and easy to manufacture.

In a first aspect of the present invention, a latch device is provided for an exit device for a door. The exit device includes a body adapted to be mounted to a side of the door. The latch device is adapted to be operably connected to the body the exit device.

The latch device includes a base adapted to be mounted to the side of the door. A first sliding member is mounted to the base and is movable relative to the base between a first position and a second position. A stop is mounted to the first sliding member and includes an abutment portion. The stop is pivotable relative to the first sliding member between a first angular position and a second angular position. A latch head is mounted to the base and is pivotable relative to the base in a pivotal path between a retracted position and an extended position. The abutment portion of the stop in the second angular position is located in the pivotal path of the latch head.

When the first sliding member moves from the first position to the second position, the stop pivots from the first angular position to the second angular position, and the abutment portion of the stop prevents the latch head from moving from the extended position to the retracted position.

Preferably, the latch head is biased by a first elastic element from the retracted position to the extended position. The stop is biased by a second elastic element from the first angular position to the second angular position. The first sliding member includes a receiving portion in which the stop is mounted. The first sliding member further includes a projection having a slant face. The stop includes a recessed portion having a slant face. When the slant face of the projection of the first sliding member abuts the slant face of the recessed portion of the stop, the stop is in the first angular position, allowing pivotal movement of the latch head. When the slant face of the projection of the first sliding member does not abut the slant face of the recessed portion of the stop, the stop is in the second angular position, preventing pivotal movement of the latch head.

Preferably, a second sliding member is mounted to the base and is movable relative to the first sliding member between a third position and a fourth position. The second sliding member is adapted to be operably connected to a press bar of the body of the exit device. The second sliding member includes a push portion. The stop includes a pushed portion. When the second sliding member moves relative to the first sliding member from the third position to the fourth position, the push portion of the second sliding member pushes the pushed portion of the stop to move the abutment portion of the stop out of the pivotal path of the latch head, and the second sliding member actuates the latch head to pivot from the extended position to the retracted position.

Preferably, the latch head includes a pin. The second sliding member includes a first cutout and a second cutout. Each of the first and second cutouts includes an inner periphery having an actuating portion. When the second sliding member moves from the third position to the fourth position, the actuating portions actuate the pin to pivot the latch head from the extended position to the retracted position.

Preferably, a limiting member is pivotably mounted to the second sliding member and includes a stop portion. The base includes a first through-slot. The first sliding member includes a second through-slot. The second sliding member includes a third through-slot. When the second sliding member is in the fourth position, the stop portion of the limiting member is biased by a third elastic element to a stop position extending through the third through-slot, the second through-slot, and the first through-slot. The stop portion of the limiting member in the stop position prevents movement of the second sliding member to prevent the latch head from moving to the extended position.

Preferably, the limiting member is pivotably mounted by an axle to the second sliding member.

Preferably, the limiting includes a through-hole. The axle includes a first portion, a second portion having a diameter smaller than a diameter of the first portion, a third portion having a diameter smaller than the diameter of the second portion, and a fourth portion having a diameter smaller than the diameter of the third portion. The second portion is located between the first and third portions. The third portion is located between the second and fourth portions. The fourth portion is mounted to the second sliding member. The third portion is received in the through-hole of the limiting member. The second portion is received in the third elastic element.

Preferably, a first pin extends through the base, the first sliding member, and the second sliding member to connect the base and the first and second sliding members.

Preferably, a second pin extends through the base, the first elastic element, and the latch head to connect the base, the first elastic element, and the latch head. The first elastic element includes a first end abutting against the latch head and a second end abutting against the first pin, biasing the latch head from the retracted position to the extended position. A third pin extends through the base, the first sliding member, the stop, the second sliding member, and the second elastic element. The second elastic element includes a first end abutting against the first pin and a second end abutting against the stop, biasing the stop from the first angular position to the second angular position.

Preferably, the base includes a first supporting portion. The first sliding member includes a second supporting portion. The second sliding member includes a third supporting portion aligned with the first and second supporting portions. The latch device further includes an adjustable rod, a first spring, and a second spring. The adjustable rod is adapted to be operably connected to the press bar of the body of the exit device. The adjustable rod extends through the first supporting portion of the base, the first spring, the second supporting portion of the first sliding member, the second spring, and the third supporting portion of the second sliding member. The first spring includes a first end abutting against the first supporting portion and a second end abutting against the second supporting portion. The first spring biases the first sliding member from the first position to the second position. The second spring includes a first end abutting against the first supporting portion and a second end abutting against the third supporting portion. The second spring biases the second sliding member to the third position at which the latch head is biased by the first elastic element from the retracted position to the extended position.

In a second aspect of the present invention, a latch device is provided for an exit device for a door. The exit device includes a body adapted to be mounted to a side of the door. The latch device includes a base adapted to be mounted to the side of the door. The base includes a first through-slot. A first sliding member is movably mounted to the base and includes a second through-slot. A second sliding member is mounted to the base and includes a third through-slot. The second sliding member is adapted to be operably connected to a press bar of the body of the exit device. A limiting member is pivotably mounted to the second sliding member and includes a stop portion. A latch head is mounted to the base and is pivotable relative to the base in a pivotal path between a retracted position and an extended position.

When the second sliding member moves to a position in which the third through-slot of the second sliding member is aligned with the second through-slot of the first sliding member and the first through-slot of the base, the stop portion of the limiting member is biased from a position received in the third through-slot to another position extending into the second through-slot and the first through-slot, avoiding movement of the second sliding member and avoiding the latch head from moving to the extended position.

In a third aspect of the present invention, a latch device is provided for an exit device for a door. The exit device includes a body adapted to be mounted to a side of the door. The latch device includes a base adapted to be mounted to the side of the door. The base includes a first through-slot. A first sliding member is movably mounted to the base. The first sliding member includes a receiving portion and a second through-slot. A second sliding member is mounted to the base and includes a third through-slot. The second sliding member is adapted to be operably connected to a press bar of the body of the exit device. A stop is mounted in the receiving portion of the first sliding member and includes an abutment portion. The stop is pivotable relative to the first sliding member between a first angular position and a second angular position. A limiting member is pivotably mounted to the second sliding member and includes a stop portion. A latch head is mounted to the base and is pivotable relative to the base between a retracted position and an extended position. The abutment portion of the stop in the second angular position abuts against the latch head.

When the first sliding member moves from the first position to the second position, the stop pivots from the first angular position to the second angular position, and the abutment portion of the stop prevents the latch head from moving from the extended position to the retracted position.

When the second sliding member moves to a position in which the third through-slot of the second sliding member is aligned with the second through-slot of the first sliding member and the first through-slot of the base, the stop portion is biased by an elastic element from a position received in the third through-slot to another position extending into the second through-slot and the first through-slot, avoiding movement of the second sliding member and avoiding the latch head from moving to the extended position.

The present invention will become clearer in light of the following detailed description of illustrative embodiments of this invention described in connection with the drawings.

### DESCRIPTION OF THE DRAWINGS

FIG. 1 is a perspective view of an exit device for a door, a top latch, and a bottom latch, with each of the top and bottom latches including a latch device according to the present invention.

FIG. 2 is a perspective view of the latch device according to the present invention.

FIG. 3 is a perspective view of a base of the latch device of FIG. 2.

FIG. 4 is a perspective view of a stop of the latch device of FIG. 2.

FIG. 5 is a perspective view of a first sliding member of the latch device of FIG. 2.

FIG. 6 is another perspective view of the first sliding member of FIG. 5.

FIG. 7 is a perspective view of a second sliding member of the latch device of FIG. 2.

FIG. 8 is another perspective view of the second sliding member of FIG. 7.

FIG. 9 is a perspective view of a limiting member of the latch device of FIG. 2.

FIG. 10 is a perspective view of an axle of the latch device of FIG. 2.

FIG. 11 is a perspective view of a latch head of the latch device of FIG. 2.

FIG. 12 is a perspective view of the latch device of FIG. 2.

FIG. 13 is a side elevational view of the latch device of FIG. 12.

FIG. 14 is a cross sectional view taken along section line 14-14 of FIG. 13.

FIG. 15 is a cross sectional view taken along section line 15-15 of FIG. 13.

FIG. 16 is a side elevational view of the latch device of FIG. 2, with portions of the latch device removed for clarity, with the latch head in an extended position, with the first sliding member in a first position, with the latch head and the first sliding member spaced from an upper striker while a door to which the latch device is mounted is in an open state.

FIG. 17 is a view similar to FIG. 16, with the latch head in the extended position, with the first sliding member retracted to a second position, and with the door in a closed state.

FIG. 18 is a view similar to FIG. 17, with an external force applied to the latch head, and with a pin of the latch head abutting against an abutment portion of the stop.

FIG. 19 is a view similar to FIG. 17, with the latch head moved to a retracted position upon pressing of a press bar of a body of the exit device mounted to the door, and with the first sliding member in the first position.

FIG. 20 is a perspective view of the latch device of FIG. 2, with the latch head in the extended position, with the first sliding member in the first position, with the base and the first sliding member spaced from the upper striker while the door in the open state, and with a stop portion of a limiting member received in a third through-slot of a second sliding member.

FIG. 21 is a perspective view similar to FIG. 20, with the latch head in the extended position, with the first sliding member retracted to the second position upon pressing by the upper striker while the door is in the closed state, and with the stop portion of the limiting member received in the third-through slot of the second sliding member.

FIG. 22 is a perspective view similar to FIG. 21, with the latch head in the retracted position, with the first sliding member in the first position, and with the second sliding member moved to a position in which the stop portion of the limiting member extends through the third-through slot of the second sliding member, a second-through slot of the first sliding member, and a first through-slot of the base.

FIG. 23 is a perspective view similar to FIG. 22, with the latch head in the retracted position, with the first sliding member pressed by the upper striker and located in the second position, and with the stop portion of the limiting member received in the third through-slot of the second sliding member.

### DETAILED DESCRIPTION OF THE INVENTION

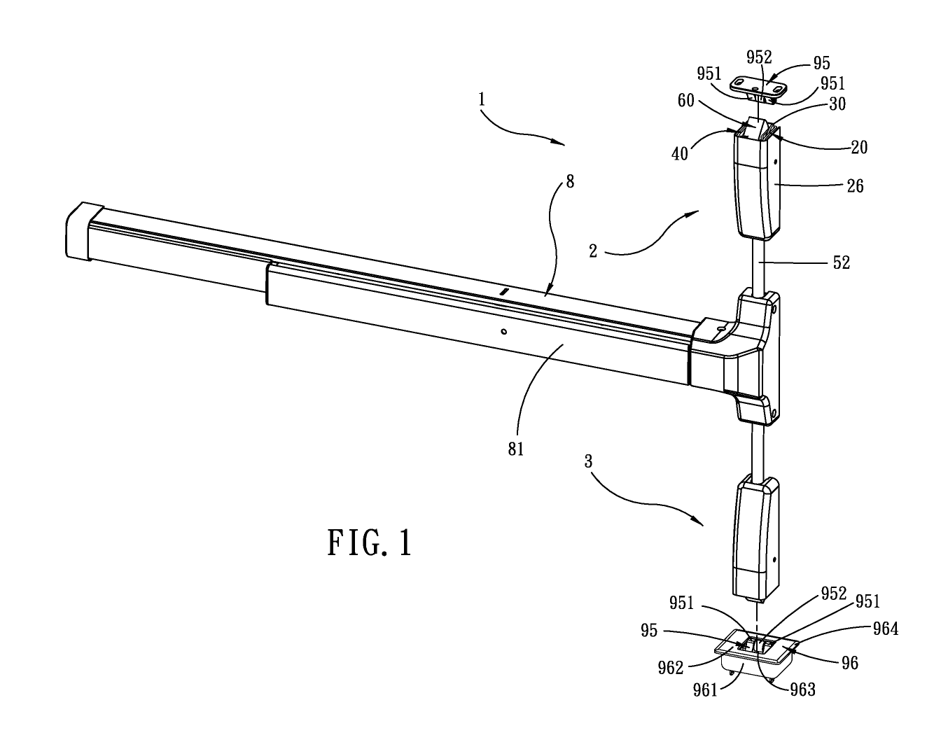

FIG. 1 shows a perspective view of an exit device 1 for a door, a top latch 2, and a bottom latch 3. The structure of the top latch 2 can be different from or the same as that of the bottom latch 3. In this embodiment, the structure of the top latch 2 is the same as that of the bottom latch 3. The exit device 1 includes a body 8 mounted to a side of a door, such as a panic exit door. The body 8 includes a press bar 81 to actuate the top and bottom latches 2 and 3. Each of the top and bottom latches 2 and 3 includes a latch device according to the present invention. In this embodiment, each of the top and bottom latches 2 and 3 includes a base 20, a first sliding member 30, a second sliding member 40, a latch head 60, a limiting member 71, a stop member 72, an axle 73, a decorative cover 26, a rod adjusting device 50, a plurality of elastic elements, a plurality of springs, and a plurality of pins.

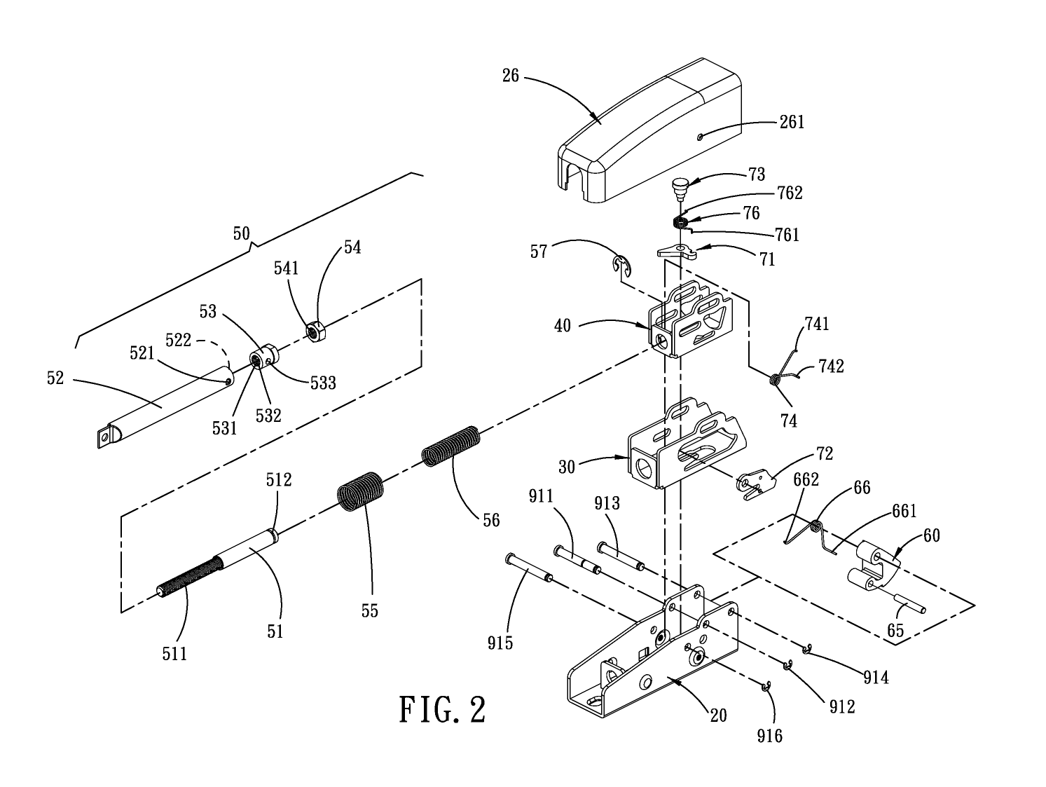

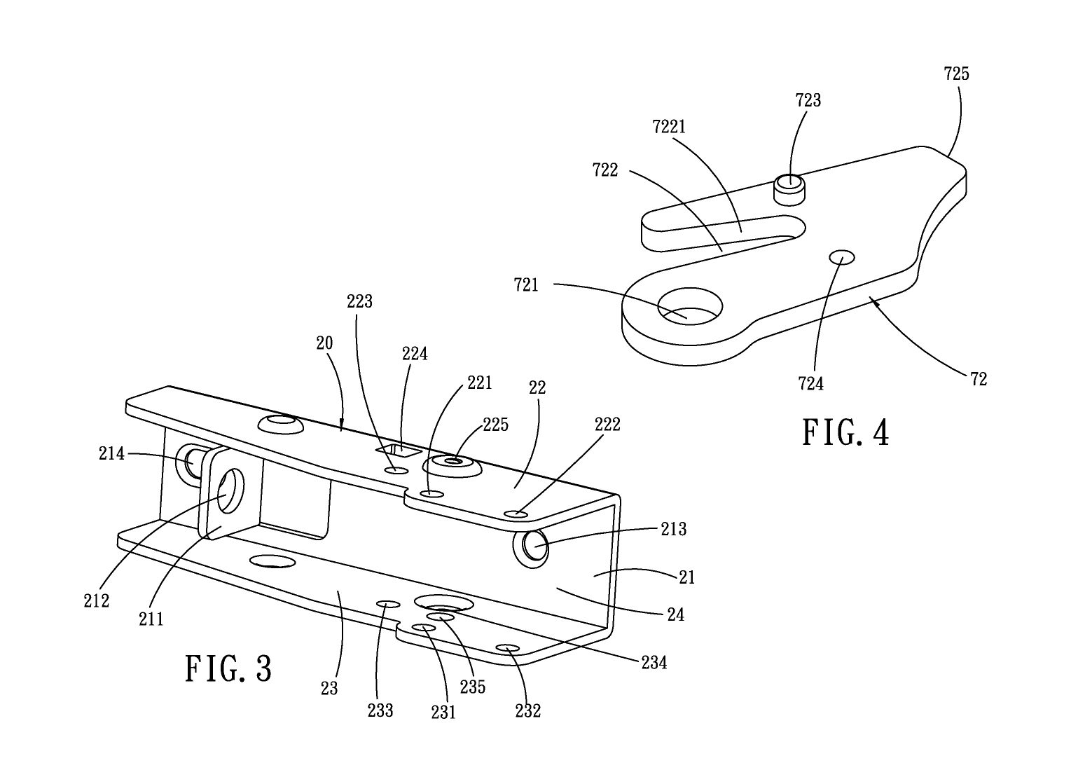

With reference to FIGS. 2 and 3, the base 20 is adapted to be mounted to the side of the door and is a substantially U-shaped plate formed by bending a plate material. The base 20 includes a first board 21, a second board 22, and a third board 23. The second and third boards 22 and 23 are respectively connected to two sides of the first board 21. The first, second, and third boards 21, 22, and 23 together define a first compartment 24. A first supporting portion 211 extends from the first board 21, is located between the second boards 22 and 23, and includes a rod receiving hole 212. The first board 21 includes a first mounting hole 213 and a second mounting hole 214. The second board 22 includes a first pin hole 221, a second pin hole 222, a third pin hole 223, a first through-slot 224, and a screw hole 225. The second board 23 includes a first pin hole 231, a second pin hole 232, a third pin hole 233, a screw hole 234, and a receiving hole 235.

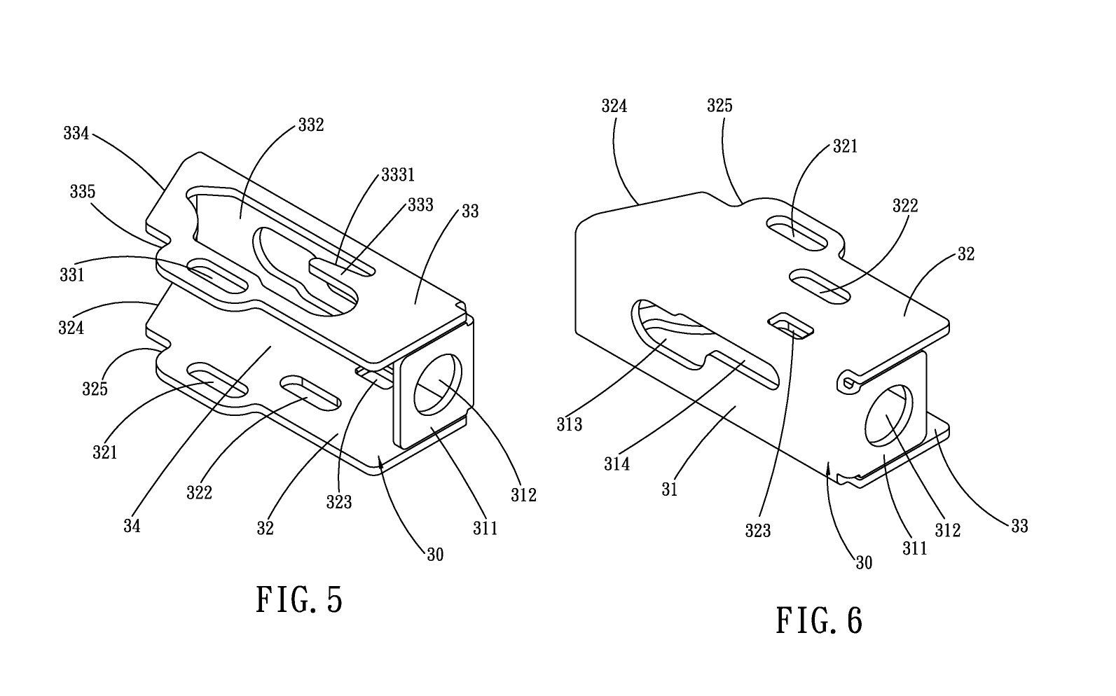

With reference to FIGS. 2, 3, 5, and 6, the first sliding member 30 includes a first plate 31, a second plate 32, and a third plate 33. The second and third plates 32 and 33 are respectively connected to two sides of the first plate 31. The first, second, and third plates 31, 32, and 33 together define a second compartment 34. A second supporting portion 311 extends from an edge between the sides of the first plate 31, is located between the second and third plates 32 and 33, and includes a rod receiving hole 312. The first plate 31 includes a first slot section 313 and a second slot section 314 in communication with the first slot section 313. The second plate 32 includes a first slot 321, a second slot 322, and a second through-slot 323. An end of the second plate 32 includes a guiding portion 324 and a shoulder 325. The third plate 33 includes a first slot 331 and a receiving portion 332. An end of the third plate 33 includes a guiding portion 334 and a shoulder 335. The receiving portion 332 includes an inner periphery having a projection 333 with a slant face 3331. The first sliding member 30 is received in the first compartment 24 of the base 20, with the first pin hole 221 of the second board 22 of the base 20 aligned with the first slot 321 of the second plate 32 of the first sliding member 30, with the first pin hole 231 of the third board 23 of the base 20 aligned with the first slot 331 of the third plate 33 of the first sliding member 30, and with the third pin hole 223 of the second board 22 of the base 20 aligned with the second slot 322 of the second plate 32 of the first sliding member 30. The first sliding member 30 is movable relative to the base 20 between a first position and a second position. In this example, a spacing between the first sliding member 30 in the second position and the body 8 of the exit device 1 is smaller than a spacing between the first sliding member 30 in the first position and the body 8 of the exit device 1.

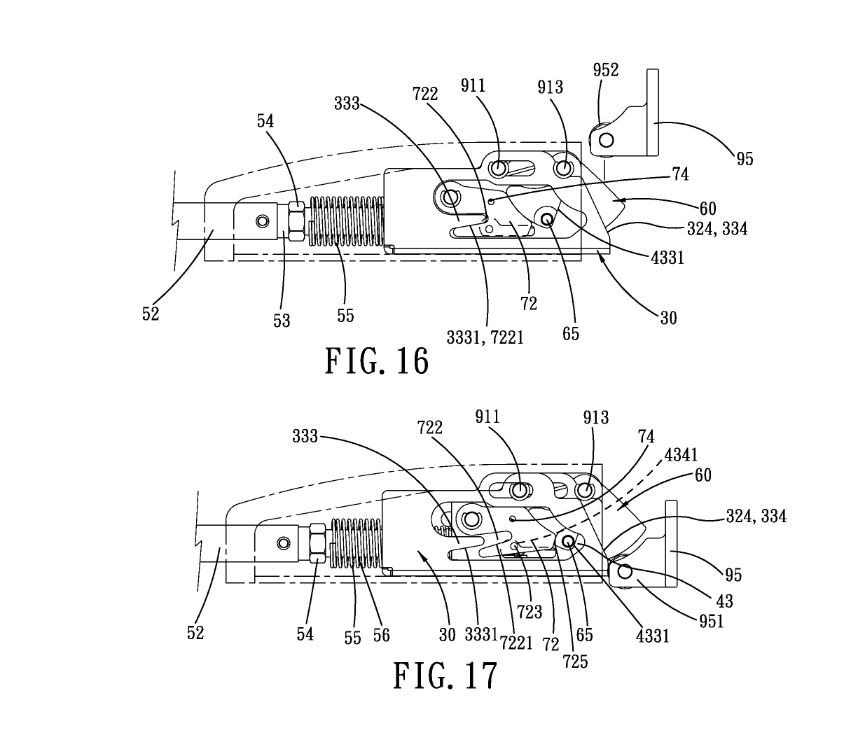

With reference to FIGS. 2-6, the stop 72 is substantially V-shaped in cross section and includes a recessed portion 722 having a slant face 7221. Furthermore, the stop 72 includes a pin hole 721, an elastic element supporting hole 724, and a pushed portion 723. The stop 72 further includes an abutment portion 725 on an outer periphery thereof. The stop 72 is mounted in the receiving portion 332 of the first sliding member 30, with the pin hole 721 aligned with the second slot 322 of the second plate 32 of the first sliding member 30. The stop 72 is pivotable relative to the first sliding member 30 between a first angular position and a second angular position. When the slant face 3331 of the projection 333 of the first sliding member 30 is in a position abutting the slant face 7221 of the recessed portion 722 of the stop 72, the stop 72 is in the first angular position, allowing pivotal movement of the latch head 60 (FIG. 16). On the other hand, when the slant face 3331 of the projection 333 of the first sliding member 30 is in another position not abutting the slant face 7221 of the recessed portion 722 of the stop 72, the stop 72 is in the second angular position, preventing pivotal movement of the latch head 60 (FIG. 17).

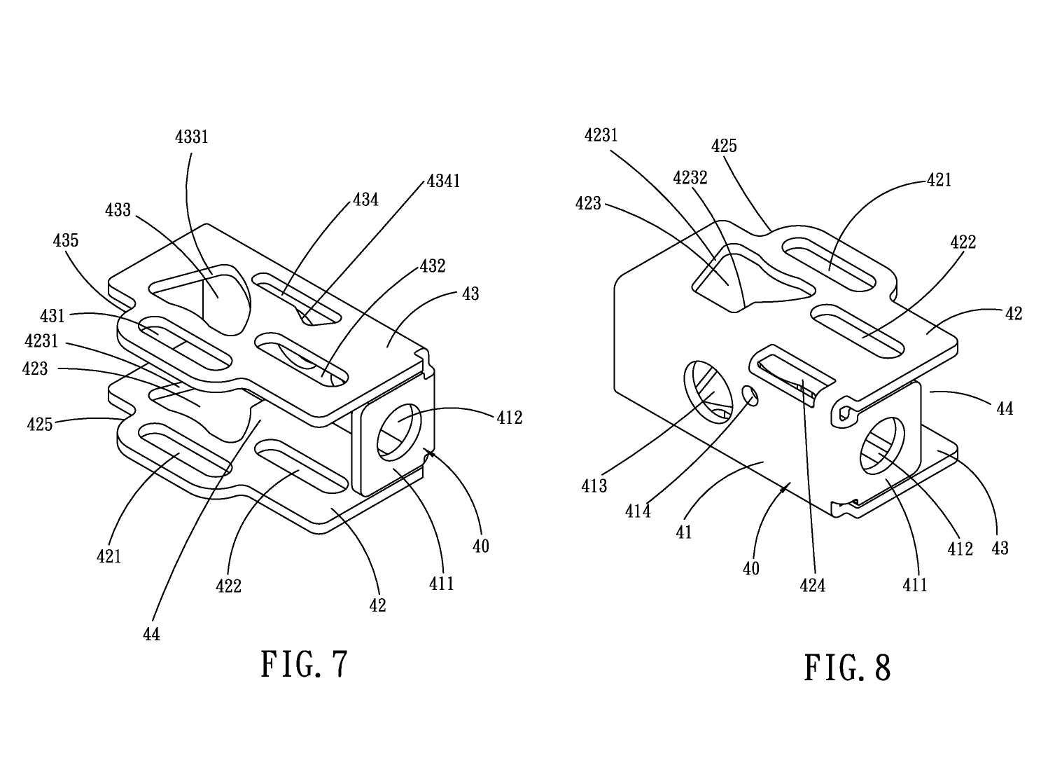

With reference to FIGS. 2-8, the second sliding member 40 is mounted to the base 20 and is adapted to be operably connected to the press bar 81 of the body 8 of the exit device 1. The second sliding member 40 includes a first plate 41, a second plate 42, and a third plate 43. The second and third plates 42 and 43 are respectively connected to two sides of the first plate 41. The first, second, and third plates 41, 42, and 43 together define a third compartment 44. A third supporting portion 411 extends from an edge between the sides of the first plate 41, is located between the second and third plates 42 and 43, and includes a rod receiving hole 412. The first plate 41 includes a through-hole 413 and a hole 414. The second plate 42 includes a third slot 421, a fourth slot 422, a third through-slot 424, and a first cutout 423. The first cutout 423 includes an inner periphery having an actuating portion 4231 and a rectilinear edge 4232. An end of the second plate 42 includes a shoulder 425. The third plate 43 includes a third slot 431, a fourth slot 432, a second cutout 433, and a fifth slot 434. The second cutout 433 includes an inner periphery having an actuating portion 4331. The fifth slot 434 includes an inner having a push portion 4341 in the form of a recessed section. An end of the third plate 43 includes a shoulder 435. The second sliding member 40 is received in the second compartment 34 of the first sliding member 30, with the third slot 421 of the second plate 42 of the second sliding member 40 aligned with the first slot 321 of the second plate 32 of the first sliding member 30, with the fourth slot 422 of the second plate 42 of the second sliding member 40 aligned with the second slot 322 of the second plate 32 of the first sliding member 30, with the third slot 431 of the third plate 43 of the second sliding member 40 aligned with the first slot 331 of the third plate 33 of the first sliding member 30, and with the pin hole 721 of the stop 72 aligned with the fourth slot 432 of the third plate 43 of the second sliding member 40. The second sliding member 40 is movable relative to the first sliding member 30 between a third position and a fourth position.

With reference to FIGS. 2-8 and 12, a first pin 911 extends through the first pin hole 221 of the second board 22 of the base 20, the first slot 321 of the second plate 32 of the first sliding member 30, the third slot 421 of the second plate 42 of the second sliding member 40, the third slot 431 of the third plate 43 of the second sliding member 40, the first slot 331 of the third plate 33 of the first sliding member 30, and the first pin hole 231 of the third board 23 of the base 20 to connect the base 20 and the first and second sliding members 30 and 40. A first retaining ring 912 is mounted to an end of the first pin 911.

With reference to FIGS. 2-8 and 11, the latch head 60 includes a latch pin hole 61, a pin hole 63, and a supporting face 62. The latch pin hole 61 of the latch head 60 is located between and aligned with the second pin hole 222 of the second board 22 of the base 20 and the second pin hole 232 of the third board 23 of the base 20. A second pin 913 extends through the second pin hole 222 of the second board 22 of the base 20, a first elastic element 66 (in the form of a torsion spring in this embodiment), the latch pin hole 61 of the latch head 60, and the second pin hole 232 of the third board 23 of the base 20. A second retaining ring 914 is mounted to an end of the second pin 913. Thus, the latch head 60 is mounted to the base 20 and pivotable relative to the base 20 in a pivotal path between a retracted position and an extended position. The abutment portion 725 of the stop 72 in the second angular position is located in the pivotal path of the latch head 60 (FIG. 17). With reference to FIG. 15, the first elastic element 66 includes a first end 661 abutting against the supporting face 62 of the latch head 60 and a second end 662 abutting against the first pin 911, allowing the latch head 60 to pivot in the pivotal path about a pivoting axis defined by the second pin 913. Namely, the first elastic element 66 biases the latch head 60 from the retracted position to the extended position. A pin 65 extends through the pin hole 63 of the latch head 60 and has two ends exposed outside of the latch head 60. The exposed ends of the pin 65 are respectively received in the first and second cutouts 423 and 433 of the second sliding member 40.

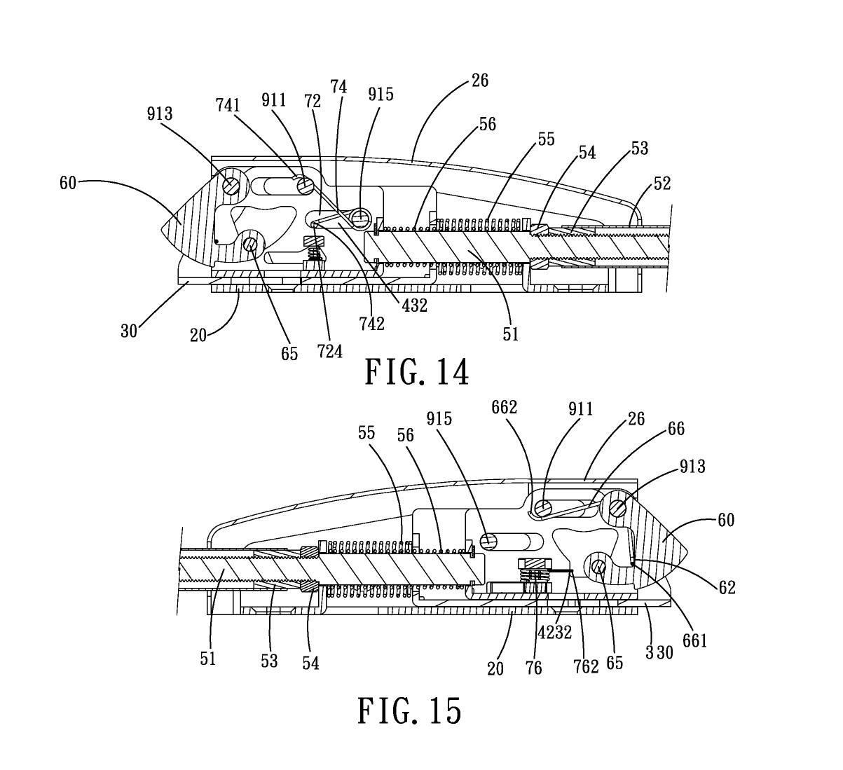

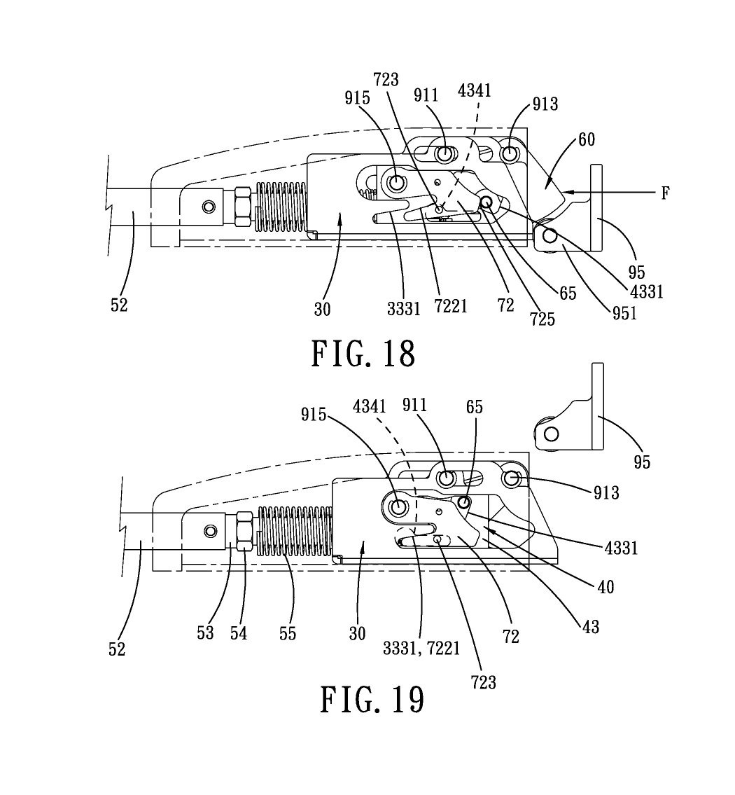

With reference to FIGS. 2-8 and 12, a third pin 915 extends through the third pin hole 223 of the second board 22 of the base 20, the second slot 322 of the second plate 32 of the first sliding member 30, the fourth slot 422 of the second plate 42 of the second sliding member 40, a second elastic element 74 (in the form of a torsion spring in this embodiment), the fourth slot 432 of the third plate 43 of the second sliding member 40, the pin hole 721 of the stop 72, and the third pin hole 233 of the third board 23 of the base 20. A third retaining ring 916 is mounted to an end of the third pin 915. With reference to FIG. 14, the second elastic element 74 includes a first end 741 abutting against the first pin 911 and a second end 742 abutting against the stop 72. In the form shown, the second end 742 of the second elastic element 74 extends through the fourth slot 432 of the third plate 43 of the second sliding member 40 and is received in the elastic element supporting hole 724 of the stop 72 to biasing the stop 72 to pivot from the first angular position to the second angular position about a pivoting axis defined by the third pin 915. The pushed portion 723 of the stop 72 can be pushed by the push portion 4341 of the second sliding member 40 (FIG. 18).

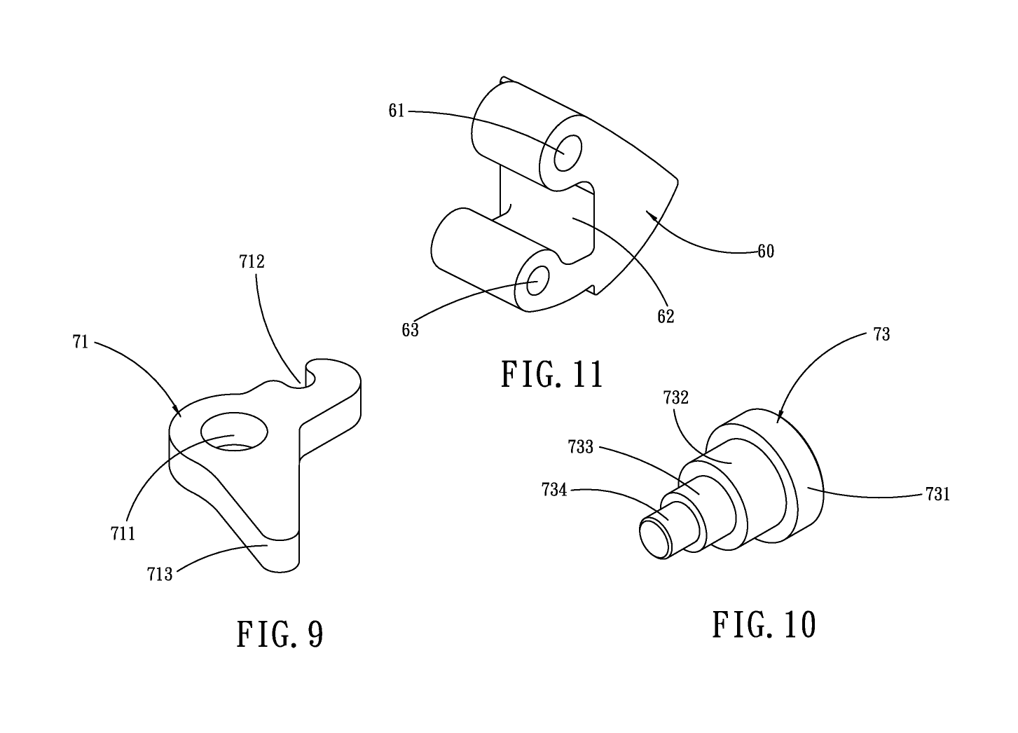

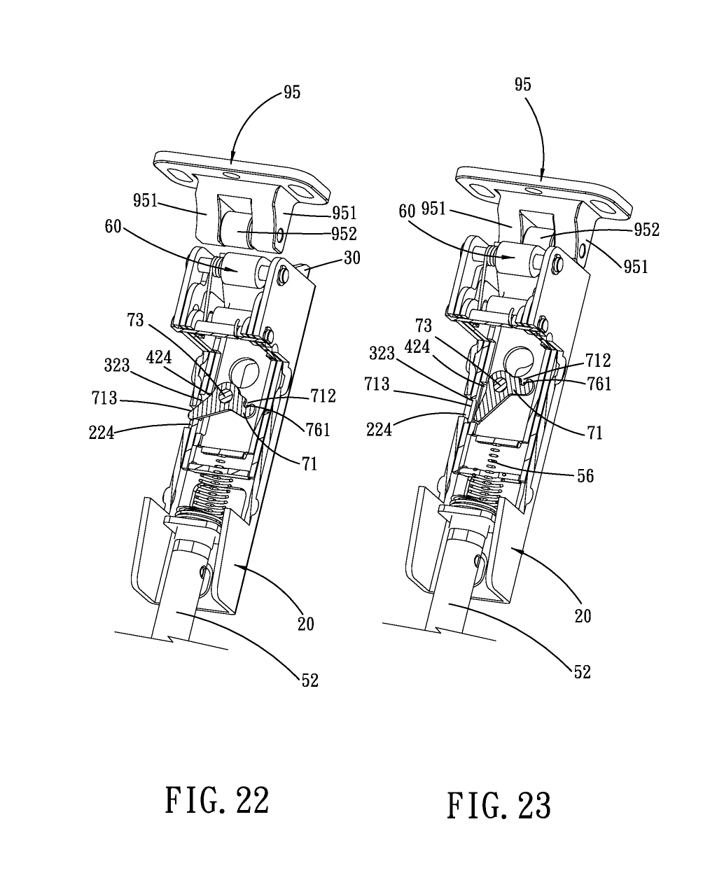

With reference to FIGS. 2-10, the limiting member 71 is in the form of a rocker having two arms in this embodiment. The limiting member 71 includes a stop portion 713, a notch 712, and a through-hole 711 located between the stop portion 713 and the notch 712. The axle 73 includes a first portion 731, a second portion 732 having a diameter smaller than a diameter of the first portion 731, a third portion 733 having a diameter smaller than the diameter of the second portion 732, and a fourth portion 734 having a diameter smaller than the diameter of the third portion 733. The second portion 732 is located between the first and third portions 731 and 733. The third portion 733 is located between the second and fourth portions 732 and 734. The axle 73 extends 15 through a third elastic element 76 (in the form of a torsion spring in this embodiment) and the through-hole 711 of the limiting member 71. The fourth portion 734 is received in the hole 414 of the second sliding member 40. The third portion 733 is received in the through-hole 711 of the limiting member 71. The second portion 732 is received in the third elastic element 76. The third elastic element 76 includes a first end 761 engaged in the notch 712 of the limiting member 71 and a second end 762 abutting against the rectilinear edge 4232 of the first cutout 423 of the second sliding member 40 (FIG. 15). The limiting member 71 is pivotably mounted by the axle 73 to the second sliding member 40 and is biased by the third elastic element 76 to pivot about a pivoting axis defined by the axle 73. The stop portion 713 of the limiting member 71 is normally in a position received in the third through-slot 424 of the second sliding member 40. When the first and second sliding members 30 and 40 slide to a predetermined position, the stop portion 713 of the limiting member 71 is biased by the third elastic element 76 to a stop position extending through the second through-slot 323 of the first sliding member 30 and the first through-slot 224 of the base 20 to restrain movement of the second sliding member 40. The first sliding member 30 can move in a reverse direction to move the stop portion 713 of the limiting member 71 out of the first through-slot 224 of the base 20 and the second through-slot 323 of the second sliding member 30 (FIGS. 22 and 23).

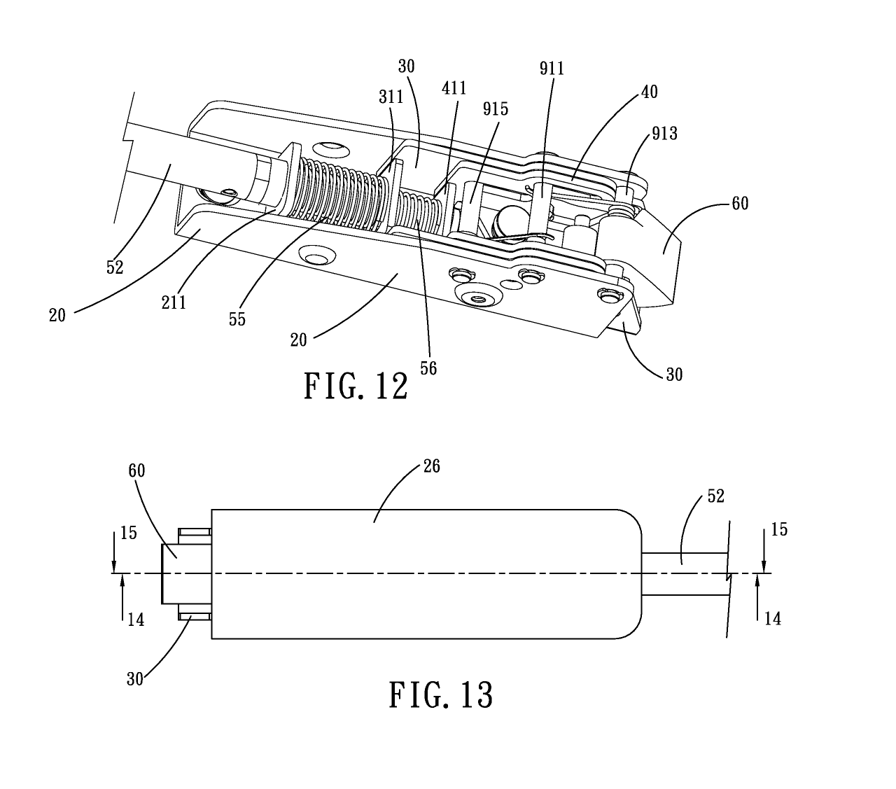

With reference to FIGS. 2 and 12, the rod adjusting device 50 includes an adjustable rod 51, a linking rod 52, a fastener 53, a nut 54, a first spring 56, and a second spring 56.

With reference to FIGS. 2-8 and 12, the first spring 55 includes a first end abutting against the first supporting portion 211 of the base 20 and a second end abutting against the second supporting portion 311 of the first sliding member 30. The first spring 55 biases the first sliding member 30 from the first position to the second position. The second spring 56 includes a first end abutting against the first supporting portion 211 of the base 20 and a second end abutting against the third supporting portion 411 of the second sliding member 40. Furthermore, the second spring 56 extends through the first spring 55 and the rod receiving hole 312 of the second supporting portion 311 of the first sliding member 30. The second spring 56 biases the second sliding member 40 to a position in which the latch head 60 is biased by the first elastic element 66 from the retracted position to the extended position.

The adjustable rod 51 is adapted to be operably connected to the press bar 81 of the body 8 of the exit device 1 via the linking rod 52. The adjustable rod 51 includes an outer thread 511 on an end thereof and a retaining groove 512 in the other end thereof. The other end of the adjustable rod 51 having the retaining groove 512 extends through the rod receiving hole 212 of the first supporting portion 211 of the base 20, the first spring 55, the rod receiving hole 312 of the second supporting portion 311 of the first sliding member 30, the second spring 56, and the rod receiving hole 412 of the third supporting portion 411 of the second sliding member 40. A fourth retaining ring 57 is mounted in the retaining groove 512, allowing the adjustable rod 51 to rotate relative to the second sliding member 40. The nut 54 includes an inner thread 541 coupled with the outer thread 511 of the adjustable rod 51. An end of the linking rod 52 is connected to the body 8 of the exit device 1. The other end of the linking rod 52 includes a hole 522 having a coupling portion 521 on an inner periphery thereof. The fastener 53 includes a hole 531 in a center thereof. The hole 531 includes an inner periphery having an inner thread 532. The fastener 53 further includes a coupling portion 533 on an outer periphery thereof. The fastener 53 is partially received in the hole 522 of the linking rod 52, with the coupling portion 533 of the fastener 53 coupled with the coupling portion 521 of the linking rod 52. The adjustable rod 51 is threadedly engaged with the inner thread 532 of the fastener 53 and can be rotated to adjust the overall length of the rod adjusting device 50.

With reference to FIGS. 1-12, the base 20 can be fixed to a side of a panic exit door by extending a bolt through the through-hole 413 of the second sliding member 40 and the first slot section 313 of the first sliding member 30 into the first mounting hole 213 of the base 20. A decorative cover 26 is provided to cover the base 20. Two screws can extend through two holes 261 in the decorative cover 26 into the screw holes 225 and 234 of the base 20.

With reference to FIGS. 1 and 2, after assembly, the body 8 of the exit device 1, the top latch 2, and the bottom latch 3 are mounted to the panic exit door. An upper striker 95 is mounted to an upper portion of a door frame of the panic exit door. A lower striker 96 is mounted to a floor or a lower portion of the door frame. The upper striker 95 includes two extensions 951 and a roller 952 between the extensions 951. The lower striker 96 includes a casing 961 receiving another upper striker 95. A faceplate 962 is provided to cover the casing 961 and the other upper striker 95 and includes a square hole 963 in a center thereof. The extensions 951 and the roller 952 of the other upper striker 95 are exposed via the square hole 963. The faceplate 962 includes an inclined face 964 facing the bottom latch 3.

With reference to FIGS. 1 and 2, since the top and bottom latches 2 and 3 have the same structure in this embodiment, the operation of the panic exit door and the latch device according to the present invention will be set forth using only the top latch 2 to avoid redundancy. However, it can be appreciated that the bottom latch 3 and the top latch 2 can have different variations to provide various functions based on the present invention.

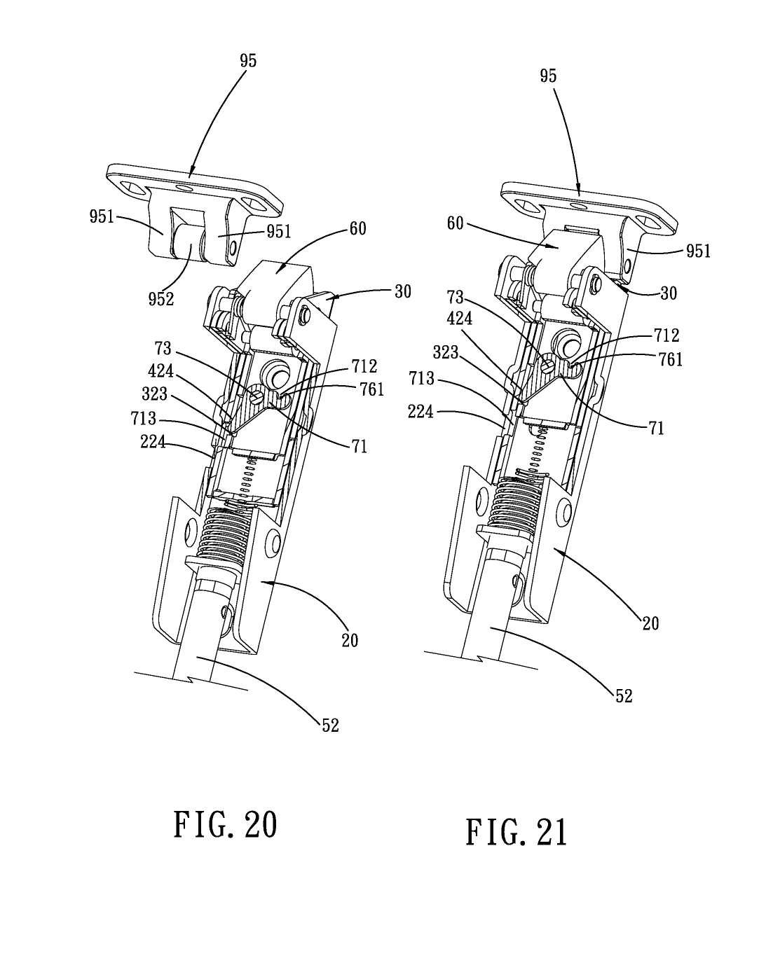

With reference to FIGS. 2-10, 16-18, and FIGS. 20-21, when the panic exit door is moved from an open state to a closed state, the latch head 60 is pressed by the roller 952 of the upper striker 95, and the guiding portions 324 and 334 of the first sliding member 30 are pressed by the extensions 951 of the upper striker 95. Thus, the latch head 60 is pressed by the roller 952 and moves from the extended position to the retracted position. When the latch head 60 slides across the roller 952, the latch head 60 is biased by the first elastic element 66 (FIG. 15) and moves from the retracted position to the extended position. At this time, since the guiding portions 324 and 334 of the first sliding member 30 are pressed by the extensions 951 of the upper striker 95, the first sliding member 30 moves from the first position to the second position. The projection 333 of the first sliding member 30 moves away from and disengages from the recessed portion 722. The stop 72 is biased by the second elastic element 74 (FIG. 14) such that the slant face 7221 of the stop 72 moves from the first angular position abutting against the slant face 3331 of the first sliding member 30 (FIG. 16) to the second angular position not abutting against the slant face 3331 (FIG. 17). The abutment portion 725 of the stop 72 in the second angular position is located in the pivotal path of the latch head 60 and abuts against the latch head 60, preventing the latch head 60 from moving from the extended position to the retracted position. Thus, even if an external force F is applied to the latch head 60 (FIG. 18), the latch head 60 will not retract into the base 20. In this case, the second through-slot 323 of the first sliding member 30 in the second position is aligned with the first through-slot 224 of the base 20 (FIG. 21).

With reference to FIGS. 2-10, 17-19, and FIG. 22, when it is desired to open the panic exit door, the press bar 81 of the body 8 of the exit device 1 is pressed to actuate the linking rod 52, which, in turn, actuates the adjustable rod 51 and the second sliding member 40, moving the second sliding member 40 from the third position toward the fourth position. The push portion 4341 of the second sliding member 40 pushes the pushed portion 723 of the stop 72, moving the stop 72 from the second angular position to the first angular position. Thus, the abutment portion 725 of the stop 72 moves away from the pin 65 of the latch head 60. One of the exposed ends of the pin 65 of the latch head 60 is pressed by the actuating portion 4231 of the second plate 42 of the second sliding member 40 (not shown in FIG. 17). The other exposed end of the pin 65 is pressed by the actuating portion 4331 of the third plate 43 of the second sliding member 40 (FIG. 17). As a result, the pin 65 of the latch head 60 pivots about the pivoting axis defined by the second pin 913 from the extended position to the retracted position. At this time, the second sliding member 40 moves toward the body 8 of the exit device 1 to the fourth position in which the third through-slot 424 of the second sliding member 40 is partially aligned with the second through-slot 323 of the first sliding member 30 and the first through-slot 224 of the base 20 (FIG. 22), the stop portion 713 of the limiting member 71 mounted to the second sliding member 40 extends from the third through-slot 424 of the second sliding member 40 into the second through-slot 323 of the second sliding member 30 and the first through-slot 224 of the base 20. In this state, the panic exit door can be pushed open. Since the extensions 951 of the upper striker 95 no longer restrain the guiding portions 324 and 334 of the first sliding member 30, the first sliding member 30 is biased by the first spring 55 such that the inner periphery of the second through-slot 323 of the first sliding member 30 pushes the stop portion 713 of the limiting member 71, moving the first sliding member 30 to the second position partially outside of the base 20. Furthermore, movement of the second sliding member 40 is limited such that the latch head 60 in the retracted position can not be biased by the first elastic element 66 to the extended position.

With reference to FIGS. 2-10 and 21-23, when the panic exit door is moved from the open state to the closed state, the guiding portions 324 and 334 of the first sliding member 30 are respectively pressed by the extensions 951 of the upper striker 95 toward the body 8 of the exit device 1 (FIG. 23). The inner periphery of the second through-slot 323 of the first sliding member 30 pushes the stop portion 713 of the limiting member 71 such that the stop portion 713 pivots through an angle and disengages from the first through-slot 224 of the base 20 and the second through-slot 323 of the first sliding member 30 (FIG. 23). In this case, the second sliding member 40 is biased by the second spring 56, and the shoulders 425 and 435 of the second sliding member 40 move to the third position abutting against the second pin 913. At this time, the actuating portions 4231 and 4331 do not restrain the pin 65 of the latch head 60. Thus, the latch head 60 is biased by the first elastic element 66 and moves from the retracted position to the extended position (FIG. 21). The panic exit door is, thus, latched.

With reference to FIGS. 1, 2, 13, and 14, in a case that the top latch 2 does not require the burglarproof function, the stop 72 can be removed such that the latch head 60 can still retract into the base 20 when the first sliding member 30 is pressed into the base 20. Furthermore, the top latch 2 does not have to include the limiting member 71. In this case, the latch head 60 can not be retained in the retracted position when the second sliding member 40 is received in the base 20 and when the first sliding member 30 is in the second position partially outside of the base 20.

Although specific embodiments have been illustrated and described, numerous modifications and variations are still possible without departing from the scope of the invention. The scope of the invention is limited by the accompanying claims.

What is claimed is:

1. A latch device for an exit device for a door, with the exit device including a body adapted to be mounted to a side of the door, with the latch device adapted to be operably connected to the body of the exit device, with the latch device comprising:
a base adapted to be mounted to the side of the door;
a first sliding member mounted to the base, with the first sliding member movable relative to the base between a first position and a second position;
a stop mounted to the first sliding member, with the stop pivotable relative to the first sliding member between a first angular position and a second angular position, with the stop including an abutment portion; and
a latch head mounted to the base, with the latch head pivotable relative to the base in a pivotal path between a retracted position and an extended position, with the abutment portion of the stop in the second angular position located in the pivotal path of the latch head,
wherein when the first sliding member moves from the first position to the second position, the stop pivots from the first angular position to the second angular position, and the abutment portion of the stop prevents the latch head from moving from the extended position to the retracted position.

2. The latch device as claimed in claim 1, further comprising:
a first elastic element biasing the latch head from the retracted position to the extended position; and
a second elastic element biasing the stop from the first angular position to the second angular position,
with the first sliding member including a receiving portion, with the stop mounted in the receiving portion of the first sliding member, with the first sliding member further including a projection having a slant face, with the stop including a recessed portion having a slant face,
wherein when the slant face of the projection of the first sliding member abuts the slant face of the recessed portion of the stop, the stop is in the first angular position, allowing pivotal movement of the latch head, and
wherein when the slant face of the projection of the first sliding member does not abut the slant face of the recessed portion of the stop, the stop is in the second angular position, preventing pivotal movement of the latch head.

3. The latch device as claimed in claim 2, further comprising:
a second sliding member mounted to the base, with the second sliding member adapted to be operably connected to a press bar of the body of the exit device, with the second sliding member movable relative to the first sliding member between a third position and a fourth position, with the second sliding member including a push portion, with the stop including a pushed portion,
wherein when the second sliding member moves relative to the first sliding member from the third position to the fourth position, the push portion of the second sliding member pushes the pushed portion of the stop to move the abutment portion of the stop out of the pivotal path of the latch head, and the second sliding member actuates the latch head to pivot from the extended position to the retracted position.

4. The latch device as claimed in claim 3, with the latch head including a pin, with the second sliding member including a first cutout and a second cutout, with each of the first and second cutouts including an inner periphery having an actuating portion,
wherein when the second sliding member moves from the third position to the fourth position, the actuating portions actuate the pin to pivot the latch head from the extended position to the retracted position.

5. The latch device as claimed in claim 3, further comprising:
a limiting member pivotably mounted to the second sliding member, with the limiting member including a stop portion; and
a third elastic element,
with the base including a first through-slot, with the first sliding member including a second through-slot, with the second sliding member including a third through-slot, with the third elastic element biasing the stop portion of the limiting member to a stop position extending through the third through-slot, the second through-slot when the second sliding member is in the fourth position, and the first through-slot, with the stop portion of the limiting member in the stop position preventing movement of the second sliding member to prevent the latch head from moving to the extended position.

6. The latch device as claimed in claim 5, further comprising: an axle, with the limiting member pivotably mounted by the axle to the second sliding member.

7. The latch device as claimed in claim 6, with the limiting including a through-hole, with the axle including a first portion, a second portion having a diameter smaller than a diameter of the first portion, a third portion having a diameter smaller than the diameter of the second portion, and a fourth portion having a diameter smaller than the diameter of the third portion, with the second portion located between the first and third portions, with the third portion located between the second and fourth portions, with the fourth portion mounted to the second sliding member, with the third portion received in the through-hole of the limiting member, with the second portion received in the third elastic element.

8. The latch device as claimed in claim 3, further comprising: a first pin extending through the base, the first sliding member, and the second sliding member to connect the base and the first and second sliding members.

9. The latch device as claimed in claim 8, further comprising:
a second pin extending through the base, the first elastic element, and the latch head to connect the base, the first elastic element, and the latch head, with the first elastic element including a first end abutting against the latch head and a second end abutting against the first pin, biasing the latch head from the retracted position to the extended position; and
a third pin extending through the base, the first sliding member, the stop, the second sliding member, and the second elastic element, with the second elastic element including a first end abutting against the first pin and a second end abutting against the stop, biasing the stop from the first angular position to the second angular position.

10. The latch device as claimed in claim 3, with the base including a first supporting portion, with the first sliding member including a second supporting portion, with the second sliding member including a third supporting portion aligned with the first and second supporting portions, with the latch device further comprising: an adjustable rod, a first spring, and a second spring, with the adjustable rod adapted to be operably connected to the press bar of the body of the exit device, with the adjustable rod extending through the first supporting portion of the base, the first spring, the second supporting portion of the first sliding member, the second spring, and the third supporting portion of the second sliding member, with the first spring including a first end abutting against the first supporting portion and a second end abutting against the second supporting portion, with the first spring biasing the first sliding member from the first position to the second position, with the second spring including a first end abutting against the first supporting portion and a second end abutting against the third supporting portion, with the second spring biasing the second sliding member to the third position at which the latch head is biased by the first elastic element from the retracted position to the extended position.

11. A latch device for an exit device for a door, with the exit device including a body adapted to be mounted to a side of the door, with the latch device comprising:
a base adapted to be mounted to the side of the door, with the base including a first through-slot;
a first sliding member movably mounted to the base, with the first sliding member including a second through-slot;
a second sliding member mounted to the base, with the second sliding member adapted to be operably connected to a press bar of the body of the exit device, with the second sliding member including a third through-slot;
a limiting member pivotably mounted to the second sliding member, with the limiting member including a stop portion; and
a latch head mounted to the base, with the latch head pivotable relative to the base in a pivotal path between a retracted position and an extended position,
wherein when the second sliding member moves to a position in which the third through-slot of the second sliding member is aligned with the second through-slot of the first sliding member and the first through-slot of the base, the stop portion of the limiting member is biased from a position received in the third through-slot to another position extending into the second through-slot and the first through-slot, avoiding movement of the second sliding member and avoiding the latch head from moving to the extended position.

12. The latch device as claimed in claim 11, with the first sliding member including a receiving portion, with the first sliding member movable relative to the base between a first position and a second position, with the latch device further comprising: a stop mounted in the receiving portion of the first sliding member, with the stop pivotable relative to the first sliding member between a first angular position and a second angular position, with the stop including an abutment portion, with the abutment portion of the stop in the second angular position located in the pivotal path of the latch head,
wherein when the first sliding member moves from the first position to the second position, the stop pivots from the first angular position to the second angular position, and the abutment portion of the stop prevents the latch head from moving from the extended position to the retracted position.

13. The latch device as claimed in claim 12, with the first sliding member including a projection having a slant face, with the stop including a recessed portion having a slant face,
wherein when the slant face of the projection of the first sliding member abuts the slant face of the recessed portion of the stop, the stop is in the first angular position, allowing pivotal movement of the latch head, and
wherein when the slant face of the projection of the first sliding member does not abut the slant face of the recessed portion of the stop, the stop is in the second angular position, preventing pivotal movement of the latch head.

14. The latch device as claimed in claim 13, further comprising:
a first elastic element biasing the latch head from the retracted position to the extended position; and
a second elastic element biasing the stop from the first angular position to the second angular position,
with the second sliding member including a push portion, with the stop including a pushed portion,
with the second sliding member movable relative to the first sliding member between a third position and a fourth position, with the third through-slot of the second sliding member aligned with the second through-slot of the first sliding member and the first through-slot of the base when the second sliding member is in the fourth position,
wherein when the second sliding member moves relative to the first sliding member from the third position to the fourth position, the push portion of the second sliding member pushes the pushed portion of the stop to move the abutment portion of the stop out of the pivotal path of the latch head, and the second sliding member actuates the latch head to pivot from the extended position to the retracted position.

15. The latch device as claimed in claim 14, with the latch head including a pin, with the second sliding member including a first cutout and a second cutout, with each of the first and second cutouts including an inner periphery having an actuating portion,
wherein when the second sliding member moves from the third position to the fourth position, the actuating portions actuate the pin to pivot the latch head from the extended position to the retracted position.

16. The latch device as claimed in claim 15, further comprising: an axle, with the limiting member pivotably mounted by the axle to the second sliding member, with the axle including a first portion, a second portion having a diameter smaller than a diameter of the first portion, a third portion having a diameter smaller than the diameter of the second portion, and a fourth portion having a diameter smaller than the diameter of the third portion, with the second portion located between the first and third portions, with the third portion located between the second and fourth portions, with the fourth portion mounted to the second sliding member, with the third portion received in a through-hole of the limiting member, with the second portion received in the third elastic element.

17. The latch device as claimed in claim 16, further comprising: a first pin extending through the base, the first sliding member, and the second sliding member to connect the base and the first and second sliding members.

18. The latch device as claimed in claim 17, further comprising:
a second pin extending through the base, the first elastic element, and the latch head to connect the base, the first elastic element, and the latch head, with the first elastic element including a first end abutting against the latch head and a second end abutting against the first pin, biasing the latch head from the retracted position to the extended position; and
a third pin extending through the base, the first sliding member, the stop, the second sliding member, and the second elastic element, with the second elastic element including a first end abutting against the first pin and a second end abutting against the stop, biasing the stop from the first angular position to the second angular position.

19. The latch device as claimed in claim 11, with the base including a first supporting portion, with the first sliding member including a second supporting portion, with the second sliding member including a third supporting portion aligned with the first and second supporting portions, with the latch device further comprising: an adjustable rod, a first spring, and a second spring, with the adjustable rod adapted to be operably connected to the press bar of the body of the exit device, with the adjustable rod extending through the first supporting portion of the base, the first spring, the second supporting portion of the first sliding member, the second spring, and the third supporting portion of the second sliding member, with the first spring including a first end abutting against the first supporting portion and a second end abutting against the second supporting portion, with the first spring biasing the first sliding member from the first position to the second position, with the second spring including a first end abutting against the first supporting portion and a second end abutting against the third supporting portion, with the second spring biasing the second sliding member to the third position at which the latch head is biased by the first elastic element from the retracted position to the extended position.

20. A latch device for an exit device for a door, with the exit device including a body adapted to be mounted to a side of the door, with the latch device comprising:
a base adapted to be mounted to the side of the door, with the base including a first through-slot;
a first sliding member movably mounted to the base, with the first sliding member including a receiving portion and a second through-slot;
a second sliding member mounted to the base, with the second sliding member adapted to be operably connected to a press bar of the body of the exit device, with the second sliding member including a third through-slot;
a stop mounted in the receiving portion of the first sliding member, with the stop pivotable relative to the first sliding member between a first angular position and a second angular position, with the stop including an abutment portion;
a limiting member pivotably mounted to the second sliding member, with the limiting member including a stop portion; and
a latch head mounted to the base, with the latch head pivotable relative to the base between a retracted position and an extended position, with the abutment portion of the stop in the second angular position abutting against the latch head,
wherein when the first sliding member moves from the first position to the second position, the stop pivots from the first angular position to the second angular position, and the abutment portion of the stop prevents the latch head from moving from the extended position to the retracted position, and
wherein when the second sliding member moves to a position in which the third through-slot of the second sliding member is aligned with the second through-slot of the first sliding member and the first through-slot of the base, the stop portion is biased by an elastic element from a position received in the third through-slot to another position extending into the second through-slot and the first through-slot, avoiding movement of the second sliding member and avoiding the latch head from moving to the extended position.
